(19) United States
(12) Patent Application Publication
(10) Pub. No.: US 2024/0380026 A1
(43) Pub. Date: Nov. 14, 2024

(54) BATTERY GAP FILLER INJECTION STRUCTURE

(71) Applicants: Huyndai Motor Company, Seoul (KR); Kia Corporation, Seoul (KR)

(72) Inventor: Kyungmo Kim, Hwaseong-si (KR)

(21) Appl. No.: 18/515,370

(22) Filed: Nov. 21, 2023

(30) Foreign Application Priority Data
May 11, 2023 (KR) 10-2023-0061037

(51) Int. Cl. H01M 10/6557; B60L 58/26; H01M 10/613; H01M 10/625

(52) U.S. Cl. CPC H01M 10/6557; B60L 58/26; H01M 10/613; H01M 10/625; H01M 2220/20

(57) ABSTRACT

An embodiment battery gap filler injection structure includes a cooling channel disposed below a battery cell and joined to a lower side of the battery cell, wherein the cooling channel is configured to allow a coolant to flow therethrough, and wherein the cooling channel includes an upper cooling channel plate disposed below the battery cell and a lower cooling channel plate disposed below the upper cooling channel plate and joined to the upper cooling channel plate to define a plurality of cooling passages, and a spacer disposed on the upper cooling channel plate, wherein the spacer is configured to contact the lower side of the battery cell to support the battery cell and to maintain a distance between the upper cooling channel plate and the lower side of the battery cell.

### CROSS-REFERENCE TO RELATED APPLICATIONS

This application claims the benefit of Korean Patent Application No. 10-2023-0061037, filed on May 11, 2023, which application is hereby incorporated herein by reference.

### TECHNICAL FIELD

The present disclosure relates to a battery gap filler injection structure of a battery system assembly for an electric vehicle.

### BACKGROUND

A gap filler is a material that serves to fill a minute gap between electronic components. The gap filler resolves obstruction of heat transfer from air or foreign matter, making it possible to quickly and effectively transfer high-temperature heat generated from a heat source to increase product durability.

In a process of manufacturing a battery system assembly for an electric vehicle, a gap filler is applied before a battery pack is seated in a lower case, which is a key process to prevent battery cells from overheating.

In addition, a cooling channel is provided below the battery system, and the cooling channel is spatially separated from an area where the battery module is mounted to prevent an internal short circuit caused by a leakage of a refrigerant. A gap filler or a gap pad for heat dissipation is applied or attached to the surface of the cooling channel to effectively dissipate heat from the battery cells to be seated in a subsequent process to the cooling channel.

However, if the flatness and alignment of the lower case and the lower side of the battery module are out of the standard range, even though a gap filler is applied at a certain thickness, a section (pore or air layer) where the cooling channel and the battery cell are not in tight contact with each other occurs, which causes a deterioration in heat transfer efficiency, leading to a deterioration in cooling performance, and as a result, shortening the lifespan of the battery system.

In order to solve this problem, a gap filler is applied as much as about 1 mm more than the amount considered appropriate in design, but this causes increases in overall weight of the battery system and material cost.

In addition, once the gap filler is applied, it is not possible to inspect whether an air layer has been created between the battery cell and the lower cooling channel after the battery module is seated.

In addition, in a case where a pack is formed in units of cells in a cell-to-pack (CTP) battery structure, there is a problem in that positions of cells may be changed due to spaces between the cells secured to insert the cells or due to surface pressure applied after the cells are mounted, and accordingly, a gap filler that has already been applied may be pushed aside or torn.

Therefore, there has been studied a technique in which a battery module is mounted in a lower case of a battery pack and then a gap filler is injected into a gap between a cooling channel and a lower side of a battery cell.

### SUMMARY

The present disclosure relates to a battery gap filler injection structure of a battery system assembly for an electric vehicle. Particular embodiments relate to a battery gap filler injection structure for injecting a gap filler between a cooling channel and a lower side of a battery cell in a battery pack.

Embodiments of the present disclosure provide a gap filler injection structure capable of injecting a gap filler into a gap between a cooling channel and a lower side of a battery cell in a battery pack in which a battery module is mounted.

An exemplary embodiment of the present disclosure provides a battery gap filler injection structure for injecting a gap filler between a cooling channel and a lower side of a battery cell in a battery pack of an electric vehicle battery system, the battery gap filler injection structure including a cooling channel in which a coolant flows, the cooling channel being disposed below the battery cell and joined to the lower side of the battery cell, wherein the cooling channel includes an upper cooling channel plate disposed below the battery cell and a lower cooling channel plate disposed below the upper cooling channel plate and joined to the upper cooling channel plate to form a plurality of cooling passages, and a spacer contacting a lower end of the battery cell to support the battery cell and maintain a distance between the upper cooling channel plate and a lower surface of the battery cell is formed on the upper cooling channel plate.

A penetrating portion for injecting a gap filler into a space between the battery cell and the cooling channel may be formed at a portion where the upper cooling channel plate and the lower cooling channel plate are joined together.

An injection nozzle may be mounted in the penetrating portion to penetrate through the cooling channel in such a manner that an outlet of the injection nozzle communicates with the space between the battery cell and the cooling channel, so that the injection nozzle supplies the gap filler into the space between the battery cell and the cooling channel.

A gap filler injection pipe may be provided at the outlet of the injection nozzle, and the gap filler injection pipe may extend from the injection nozzle to the space between the battery cell and the cooling channel to inject the gap filler supplied from the injection nozzle into the space between the battery cell and the cooling channel.

The upper cooling channel plate and the lower cooling channel plate may be joined to each other by brazing with a gap therebetween, and gap filler injection holes may be formed at the brazing joint portion in such a manner as to communicate with each other at the same positions of the upper cooling channel plate and the lower cooling channel plate.

The gap filler injection pipe may communicate with the space between the battery cell and the cooling channel by penetrating through the gap filler injection holes.

The spacer may be integrally formed with the upper cooling channel plate and may be formed to protrude from the upper cooling channel plate toward the lower surface of the battery cell in an oblique direction and be bent to extend in a direction parallel to the lower surface of the battery cell.

The upper cooling channel plate may be partitioned into a plurality of regions, each including a gap filler injection hole formed to correspond to a position of the battery cell.

The battery gap filler injection structure may further include an intermediate cooling channel plate disposed between the upper cooling channel plate and the lower cooling channel plate, an upper surface of the intermediate cooling channel plate being joined by brazing to the upper cooling channel plate and a lower surface of the intermediate cooling channel plate being joined by brazing to the lower cooling channel plate.

A plurality of upper cooling channel plates may be formed, a plurality of openings may be formed in the intermediate cooling channel plate to correspond to the plurality of upper cooling channel plates, and edges of the plurality of upper cooling channel plates may be seated on the intermediate cooling channel plate at edges of the openings.

According to an exemplary embodiment of the present disclosure, by using a technique in which a gap filler is injected into a gap between the cooling channel and the lower side of the battery cell after mounting a battery module in a lower case of a battery pack, the gap filler is injected as much as the gap, thereby optimizing a gap filler injection amount.

In addition, as the gap filler is injected into the gap between the cooling channel and the lower side of the battery cell, an air layer existing in the gap is pushed out and removed, thereby fundamentally preventing an air layer from being formed in the gap between the cooling channel and the lower side of the battery cell and requiring no separate inspection as to whether an air layer has been formed.

In addition, in a case where a pack is formed in units of cells in a cell-to-pack (CTP) battery structure, it is possible to fundamentally prevent a gap filler layer from being pushed aside or being torn even if positions of cells are changed.

### BRIEF DESCRIPTION OF THE DRAWINGS

FIG. 1 is a view showing how a battery cell and a cooling channel are coupled to each other in a battery system to which a battery gap filler injection structure according to an exemplary embodiment of the present disclosure is applied.

FIG. 2 is a view illustrating how a gap filler is injected between the cooling channel and a lower side of the battery cell by the battery gap filler injection structure according to an exemplary embodiment of the present disclosure.

FIG. 3 is an enlarged view illustrating an injection nozzle and a lower cooling channel plate of the battery gap filler injection structure according to an exemplary embodiment of the present disclosure.

FIG. 4 is a view for explaining inspection as to whether injection is completed after a gap filler is injected by the battery gap filler injection structure according to an exemplary embodiment of the present disclosure.

FIG. 5 is a view illustrating an example of the cooling channel of the battery gap filler injection structure according to an exemplary embodiment of the present disclosure.

FIG. 6 is a view illustrating a coupled state of the cooling channel illustrated in FIG. 5.

FIG. 7 is a view illustrating another example of the cooling channel of the battery gap filler injection structure according to an exemplary embodiment of the present disclosure.

FIG. 8 is a view illustrating a coupled state of the cooling channel illustrated in FIG. 7.

FIG. 9 is a view illustrating a state of the cooling channel illustrated in FIG. 7 before an upper cooling channel plate is coupled to a lower cooling channel plate.

### DETAILED DESCRIPTION OF ILLUSTRATIVE EMBODIMENTS

Hereinafter, exemplary embodiments of the present disclosure will be described in detail with reference to the accompanying drawings, so that so that they can be easily carried out by those of ordinary skill in the art to which the present disclosure pertains. Embodiments of the present disclosure may be implemented in various different forms and are not limited to the exemplary embodiments described herein.

In addition, in describing various exemplary embodiments, the same configuration will be representatively described in one exemplary embodiment using the same reference numerals for same components, and only configurations different from those in the one exemplary embodiment will be described in the other exemplary embodiments.

It should be noted that the drawings are schematic and not drawn to scale. The relative dimensions and proportions of parts in the drawings may be exaggerated or diminished in size for the sake of clarity and convenience in the drawings, and any dimensions are merely illustrative and are not limiting. The same reference signs are used for the same structures, elements, or parts shown in two or more drawings to show similar features. When one part is referred to as being “over” or “on” another part, the one part may be directly over or on the other part, or there may be an intervening part therebetween.

Exemplary embodiments of the present disclosure are represented by one specific exemplary embodiment of the present disclosure. As a result, various modifications of the drawings are expected. Therefore, the exemplary embodiments are not limited to specific forms of illustrated regions and include modifications of the forms caused, for example, in the manufacturing process.

Hereinafter, a battery gap filler injection structure according to embodiments of the present disclosure will be described in detail with reference to the accompanying drawings.

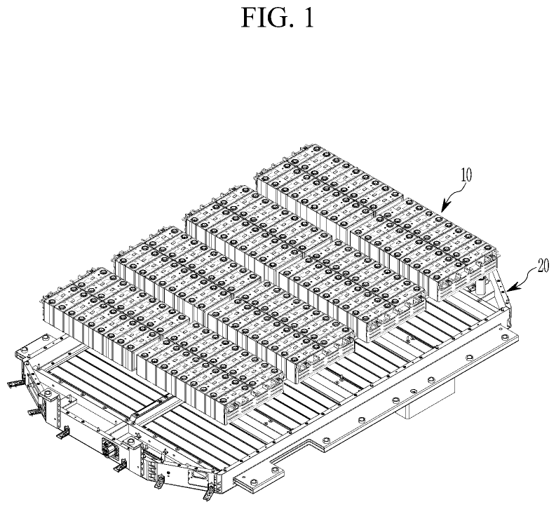

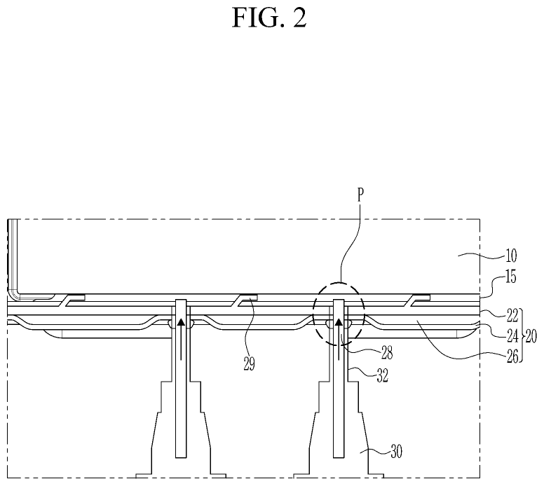

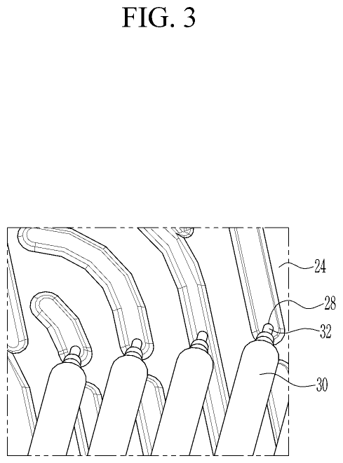

FIG. 1 is a view showing how a battery cell and a cooling channel are coupled to each other in a battery system to which the battery gap filler injection structure according to an exemplary embodiment of the present disclosure is applied. FIG. 2 is a view illustrating how a gap filler is injected between the cooling channel and a lower side of the battery cell by the battery gap filler injection structure according to an exemplary embodiment of the present disclosure. FIG. 3 is an enlarged view illustrating an injection nozzle and a lower cooling channel plate of the battery gap filler injection structure according to an exemplary embodiment of the present disclosure.

As illustrated in FIG. 1, a battery pack of an electric vehicle battery system includes a cooling channel 20 and a battery cell 10, and the battery cell 10 is mounted on the cooling channel 20 before a gap filler is injected.

Referring to FIGS. 2 and 3, the cooling channel 20 is disposed below the battery cell 10, and cooling passages 26 in which a coolant flows are formed in the cooling channel 20. The coolant releases heat generated from the battery cell 10 to the outside to cool the battery cell 10 and keep the battery cell 10 at an appropriate temperature.

A penetrating portion P for injecting a gap filler into a space between the battery cell 10 and the cooling channel 20 is formed at a portion where the cooling channel 20 and the battery cell 10 are joined together.

The cooling channel 20 includes an upper cooling channel plate 22 and a lower cooling channel plate 24 disposed below the battery cell 10, and the upper cooling channel plate 22 and the lower cooling channel plate 24 are joined together in a vertical direction with the cooling passages 26 formed therebetween.

A plurality of points at which the upper cooling channel plate 22 and the lower cooling channel plate 24 are joined together may be formed at regular intervals, or a point at which the upper cooling channel plate 22 and the lower cooling channel plate 24 are joined together may extend in a longitudinal direction of the cooling channel 20. The upper cooling channel plate 22 and the lower cooling channel plate 24 may be joined together by brazing. In addition, gap filler injection holes 28 may be formed at the brazing joint portion in such a manner that the upper cooling channel plate 22 and the lower cooling channel plate 24 communicate with each other at the same location.

Meanwhile, a spacer 29 may be formed on the upper cooling channel plate 22 to maintain a minimum distance between the upper cooling channel plate 22 and the lower side of the battery cell 10. The spacer 29 may protrude integrally with the upper cooling channel plate 22 and may be formed in a curved wing shape to contact a lower surface of the battery cell 10. That is, the spacer 29 may be integrally formed with the upper cooling channel plate 22 and may be formed to protrude from the upper cooling channel plate 22 toward the lower surface of the battery cell 10 in an oblique direction and be bent to extend in a direction parallel to the lower surface of the battery cell 10. A plurality of spacers 29 may be formed at positions corresponding to the plurality of cooling passages 26.

The gap filler may be injected into the space 15 between the battery cell 10 and the cooling channel 20 by an injection nozzle 30 through the gap filler injection holes 28 of the penetrating portion P. The injection nozzle 30 may be disposed below the lower cooling channel plate 24, and a plurality of injection nozzles 30 may be provided at positions corresponding to the plurality of gap filler injection holes 28. An outlet of the injection nozzle 30 is positioned to face the gap filler injection hole 28.

A gap filler injection pipe 32 may be provided at the outlet of the injection nozzle 30, and the gap filler injection pipe 32 may extend from the injection nozzle 30 to the space 15 between the battery cell 10 and the cooling channel 20. The gap filler supplied from the injection nozzle 30 may be injected into the space 15 between the battery cell 10 and the cooling channel 20 via the gap filler injection pipe 32. The gap filler injection pipe 32 may be integrally formed with the outlet of the injection nozzle 30.

The gap filler injection pipe 32 may be inserted into the gap filler injection hole 28 and extend over an upper surface of the upper cooling channel plate 22. A portion of the gap filler injection pipe 32 inserted into the gap filler injection hole 28 may be sealed to prevent a leakage of the gap filler injected into the space between the battery cell 10 and the cooling channel 20 to the outside.

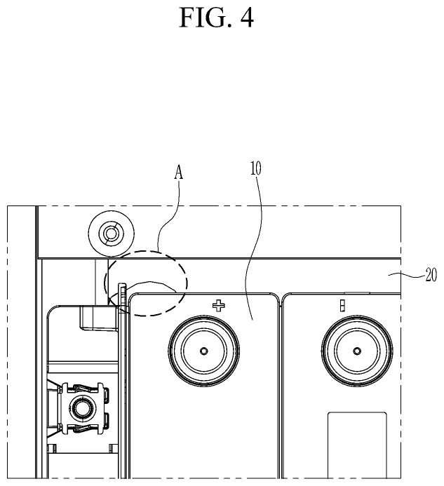

FIG. 4 is a view for explaining inspection as to whether injection is completed after the gap filler is injected by the battery gap filler injection structure according to an exemplary embodiment of the present disclosure.

As illustrated in FIG. 4, when the gap filler is sufficiently injected into the space between the battery cell 10 and the cooling channel 20, it may be checked whether the injection of the gap filler is completed by detecting whether the gap filler overflows with naked eyes or through a color difference detection sensor. The color difference detection sensor may determine overflow by emitting light with red (R), green (G), and blue (B) components to an overflow-expected point (portion ‘A’), receiving reflected light with a photodiode, calculating proportions of RGB amounts of the received light, and determining a color.

The point at which the gap filler overflows may be set in advance, and this point may be set by selecting a point where the gap filler last arrives when the gap filler is injected in the upper cooling channel plate 22.

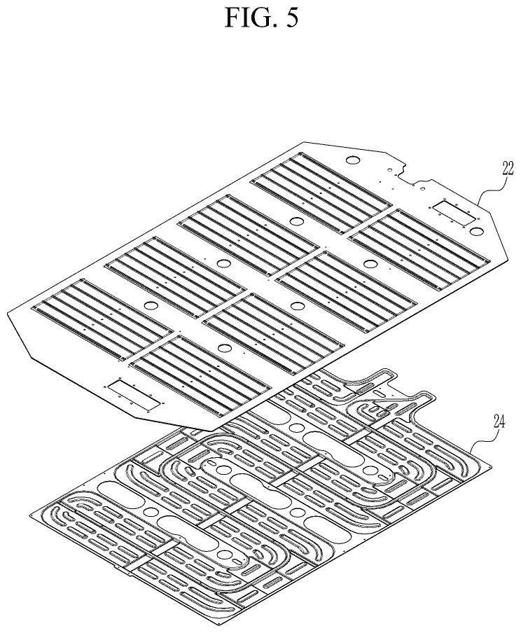

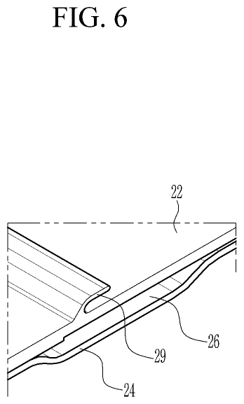

FIG. 5 is a view illustrating an example of the cooling channel of the battery gap filler injection structure according to an exemplary embodiment of the present disclosure. FIG. 6 is a view illustrating a coupled state of the cooling channel illustrated in FIG. 5.

As illustrated in FIGS. 5 and 6, the cooling channel 20 may be formed in such a manner that one upper cooling channel plate 22 is joined to one lower cooling channel plate 24.

A plurality of curved and continuous grooves may be formed in the lower cooling channel plate 24, and the plurality of grooves become a plurality of cooling passages 26 when the upper cooling channel plate 22 is coupled to the lower cooling channel plate 24. An area of the lower cooling channel plate 24 in which the plurality of grooves are not formed may be joined to the upper cooling channel plate 22 by brazing to prevent coolants flowing through the plurality of cooling passages 26 from being mixed with each other.

Meanwhile, the upper cooling channel plate 22 may be partitioned into a plurality of regions, each including a gap filler injection hole formed to correspond to the position of the battery cell 10. Accordingly, the gap filler may be selectively injected into the space 15 between the battery cell 10 and the cooling passage 26 at a desired point.

The spacer 29 protruding upward from the upper cooling channel plate 22 above the cooling passages 26 and having a curved wing shape may be integrally formed with the upper cooling channel plate 22, and an upper surface of the spacer 29 may contact the lower surface of the battery cell 10 to support the battery cell 10 and maintain a minimum distance between the battery cell 10 and the upper cooling channel plate 22.

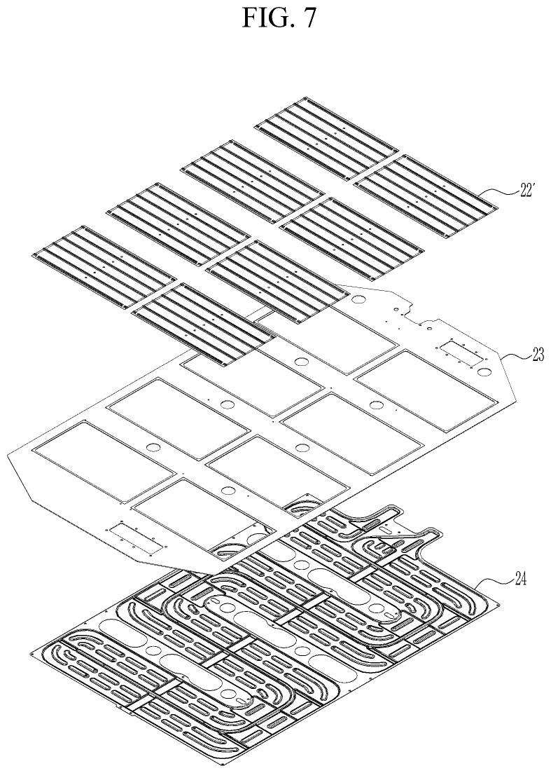

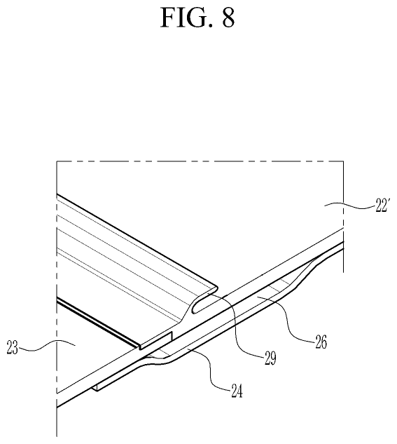

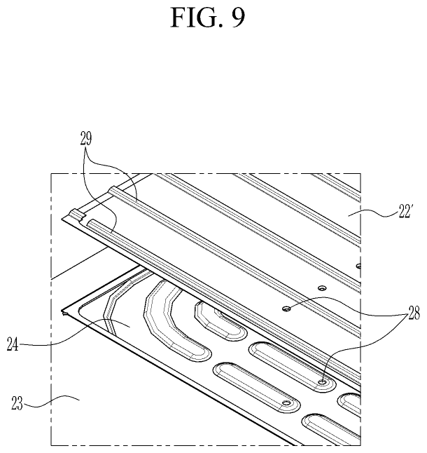

FIG. 7 is a view illustrating another example of the cooling channel of the battery gap filler injection structure according to an exemplary embodiment of the present disclosure. FIG. 8 is a view illustrating a coupled state of the cooling channel illustrated in FIG. 7. FIG. 9 is a view illustrating a state of the cooling channel illustrated in FIG. 7 before an upper cooling channel plate is coupled to a lower cooling channel plate.

Referring to FIGS. 7 to 9, the cooling channel 20 may be formed in such a manner that an intermediate cooling channel plate 23 and an upper cooling channel plate 22′ are joined to the lower cooling channel plate 24. A plurality of upper cooling channel plates 22′ may be formed, and the intermediate cooling channel plate 23 may include a plurality of openings in which the plurality of upper cooling channel plates 22′ are seated at edges thereof. That is, a lower surface of the intermediate cooling channel plate 23 may be joined by brazing to an area of the lower cooling channel plate 24 where the plurality of grooves are not formed, and the upper cooling channel plates 22′ may be seated on and joined by brazing to the upper surface of the intermediate cooling channel plate 23 at the edges of the openings.

A plurality of wing-shaped spacers 29 may be formed on the upper cooling channel plate 22′ in a longitudinal direction of the upper cooling channel plate 22′, and a plurality of gap filler injection holes 28 may be formed between the plurality of spacers 29 in such a manner as to communicate with each other in the vertical direction at the same positions of the upper cooling channel plate 22′ and the lower cooling channel plate 24.

The battery gap filler injection structure according to an exemplary embodiment of the present disclosure as described above is capable of injecting a gap filler as much as a gap between the cooling channel and the lower side of the battery cell by using a technique in which the gap filler is injected into the gap after mounting a battery module in a lower case of a battery pack, thereby optimizing a gap filler injection amount.

In addition, as the gap filler is injected into the gap between the cooling channel and the lower side of the battery cell, an air layer existing in the gap is pushed out and removed, thereby fundamentally preventing an air layer from being formed in the gap between the cooling channel and the lower side of the battery cell and requiring no separate inspection as to whether an air layer has been formed.

In addition, in a case where a pack is formed in units of cells in a cell-to-pack (CTP) battery structure, it is possible to fundamentally prevent a gap filler layer from being pushed aside or being torn even if positions of cells are changed.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

The following reference identifiers may be used in connection with the drawings to describe various features of embodiments of the present disclosure.

| | |
|---|---|
| 10: battery cell | 20: cooling channel |
| 22, 22′: upper cooling channel | 23: intermediate cooling channel |
| plate | plate |
| 24: lower cooling channel plate | 26: cooling passage |
| 28: gap filler injection hole | 29: spacer |
| 30: injection nozzle | 32: gap filler injection pipe |

What is claimed is:

1. A battery gap filler injection structure comprising:
a cooling channel disposed below a battery cell and joined to a lower side of the battery cell, wherein the cooling channel is configured to allow a coolant to flow therethrough, and wherein the cooling channel comprises:
an upper cooling channel plate disposed below the battery cell; and
a lower cooling channel plate disposed below the upper cooling channel plate and joined to the upper cooling channel plate to define a plurality of cooling passages; and
a spacer disposed on the upper cooling channel plate, wherein the spacer is configured to contact the lower side of the battery cell to support the battery cell and to maintain a distance between the upper cooling channel plate and the lower side of the battery cell.

2. The structure of claim 1, wherein a penetrating portion is disposed at a portion where the upper cooling channel plate and the lower cooling channel plate are joined together, and wherein the penetrating portion is configured to inject a gap filler into a space between the battery cell and the cooling channel.

3. The structure of claim 2, wherein an injection nozzle is mounted in the penetrating portion to penetrate through the cooling channel in such a manner that an outlet of the injection nozzle communicates with the space between the battery cell and the cooling channel, and wherein the injection nozzle is configured to supply the gap filler into the space between the battery cell and the cooling channel.

4. The structure of claim 3, further comprising a gap filler injection pipe disposed at the outlet of the injection nozzle, wherein the gap filler injection pipe extends from the injection nozzle to the space between the battery cell and the cooling channel and is configured to inject the gap filler supplied from the injection nozzle into the space between the battery cell and the cooling channel.

5. The structure of claim 4, wherein:
the upper cooling channel plate and the lower cooling channel plate are joined to each other at brazing joint portions with a gap therebetween; and
gap filler injection holes are disposed at the brazing joint portions in such a manner as to communicate with each other at the same positions of the upper cooling channel plate and the lower cooling channel plate.

6. The structure of claim 5, wherein the gap filler injection pipe is configured to communicate with the space between the battery cell and the cooling channel by penetrating through the gap filler injection holes.

7. The structure of claim 1, wherein the spacer is integral with the upper cooling channel plate, protrudes from the upper cooling channel plate toward the lower side of the battery cell in an oblique direction, and is bent to extend in a direction parallel to the lower side of the battery cell.

8. The structure of claim 1, wherein the upper cooling channel plate is partitioned into a plurality of regions, each region of the plurality of regions including a gap filler injection hole corresponding to a position of the battery cell.

9. A battery gap filler injection structure comprising:
a cooling channel disposed below a battery cell and joined to a lower side of the battery cell, wherein the cooling channel is configured to allow a coolant to flow therethrough, and wherein the cooling channel comprises:
a plurality of upper cooling channel plates disposed below the battery cell;
a lower cooling channel plate disposed below the upper cooling channel plates and joined to the upper cooling channel plates to define a plurality of cooling passages; and
an intermediate cooling channel plate disposed between the upper cooling channel plates and the lower cooling channel plate, an upper surface of the intermediate cooling channel plate being joined to the upper cooling channel plates and a lower surface of the intermediate cooling channel plate being joined to the lower cooling channel plate; and
spacers disposed on the upper cooling channel plates, wherein the spacers are configured to contact the lower side of the battery cell to support the battery cell and to maintain a distance between the upper cooling channel plates and the lower side of the battery cell.

10. The structure of claim 9, wherein:
a plurality of openings are disposed in the intermediate cooling channel plate to correspond to the upper cooling channel plates; and
edges of the upper cooling channel plates are seated on the intermediate cooling channel plate at edges of the openings.

11. The structure of claim 9, further comprising penetrating portions disposed at portions where the upper cooling channel plates and the lower cooling channel plate are joined together, wherein the penetrating portions are configured to inject a gap filler into a space between the battery cell and the cooling channel.

12. The structure of claim 11, wherein:
injection nozzles are mounted in the penetrating portions to penetrate through the cooling channel in such a manner that outlets of the injection nozzles communicate with the space between the battery cell and the cooling channel; and
the injection nozzles are configured to supply the gap filler into the space between the battery cell and the cooling channel.

13. The structure of claim 12, further comprising gap filler injection pipes disposed at the outlets of the injection nozzles, wherein the gap filler injection pipes extend from the injection nozzles to the space between the battery cell and the cooling channel and are configured to inject the gap filler supplied from the injection nozzles into the space between the battery cell and the cooling channel.

14. The structure of claim 13, wherein:
the upper cooling channel plates and the lower cooling channel plate are joined to each other at brazing joint portions with a gap therebetween; and
gap filler injection holes are disposed at the brazing joint portions in such a manner as to communicate with each other at the same positions of the upper cooling channel plates and the lower cooling channel plate.

15. The structure of claim 14, wherein the gap filler injection pipes are configured to communicate with the space between the battery cell and the cooling channel by penetrating through the gap filler injection holes.

16. The structure of claim 9, wherein the spacers are integral with the upper cooling channel plates, protrude from the upper cooling channel plates toward the lower side of the battery cell in an oblique direction, and are bent to extend in a direction parallel to the lower side of the battery cell.

17. A method for injecting a gap filler in an electric vehicle battery system, the method comprising:
mounting a battery module in a lower case of a battery pack;
injecting the gap filler into a space between a cooling channel and a lower side of a battery cell of the battery module after mounting the battery module, wherein the cooling channel is disposed below the battery cell and joined to the lower side of the battery cell, wherein the cooling channel allows a coolant to flow therethrough, and wherein the cooling channel comprises:
an upper cooling channel plate disposed below the battery cell, wherein a spacer is disposed on the upper cooling channel plate, and wherein the spacer is configured to contact the lower side of the battery cell to support the battery cell and to maintain a distance between the upper cooling channel plate and the lower side of the battery cell; and
a lower cooling channel plate disposed below the upper cooling channel plate and joined to the upper cooling channel plate to define a plurality of cooling passages.

18. The method of claim 17, wherein injecting the gap filler into the space comprises injecting the gap filler through a penetrating portion disposed at a portion where the upper cooling channel plate and the lower cooling channel plate are joined together.

19. The method of claim 18, wherein injecting the gap filler into the space comprises supplying the gap filler into the space through an injection nozzle mounted in the penetrating portion to penetrate through the cooling channel in such a manner that an outlet of the injection nozzle communicates with the space between the battery cell and the cooling channel.

20. The method of claim 19, wherein injecting the gap filler into the space comprises injecting the gap filler supplied from the injection nozzle into the space between the battery cell and the cooling channel using a gap filler injection pipe disposed at the outlet of the injection nozzle, wherein the gap filler injection pipe extends from the injection nozzle to the space between the battery cell and the cooling channel.
